(19) United States
(12) Patent Application Publication
(10) Pub. No.: US 2021/0123265 A1
(43) Pub. Date: Apr. 29, 2021

(54) COMBINATION WALL PROTECTOR AND DOOR CATCH

(71) Applicant: Steven James Kaufmann, Holladay, UT (US)

(72) Inventor: Steven James Kaufmann, Holladay, UT (US)

(21) Appl. No.: 16/663,834

(22) Filed: Oct. 25, 2019

(51) Int. Cl. E05B 1/00; E05F 5/02; E05B 17/00

(52) U.S. Cl. CPC E05B 1/0061; E05B 17/005; E05F 5/02

(57) ABSTRACT

An apparatus including a wall plate, a retaining strap, and a storage groove. The wall plate is attachable to a wall and includes a door facing surface. The door facing surface is configured to stop a door knob extending from a door. The retaining strap is coupled with the wall plate and forms a loop. The loop extends from the wall plate and engages the door knob. The storage groove is disposed between a perimeter of the wall plate and the wall. The storage groove is configured to receive the retaining strap.

### FIELD

This invention relates to a wall protector and more particularly relates to a combination wall protector and door catch.

### BACKGROUND

Door handles are a convenient and useful structure for opening doors. Handles provide protruding structures that facilitate human interaction and provide securing features to lock or simply close the door. When the door is open, the door handle provides a location to grip and control the door. Handles are implemented on interior and exterior doors.

### SUMMARY

An apparatus is described. The apparatus includes a wall plate, a retaining strap, and a storage groove. The wall plate is attachable to a wall and includes a door facing surface. The door facing surface is configured to stop a door knob extending from a door. The retaining strap is coupled with the wall plate and forms a loop. The loop extends from the wall plate and engages the door knob. The storage groove is disposed between a perimeter of the wall plate and the wall. The storage groove is configured to receive the retaining strap.

A system is also described. The system includes an apparatus and a fastener. The apparatus is to mount to a wall to protect the wall from impact by a door knob. The apparatus includes a wall plate, a retaining strap, and a storage groove. The wall plate is attachable to a wall and includes a door facing surface. The door facing surface is configured to stop a door knob extending from a door. The retaining strap is coupled with the wall plate and forms a loop. The loop extends from the wall plate and engages the door knob. The storage groove is disposed between a perimeter of the wall plate and the wall. The storage groove is configured to receive the retaining strap. The fastener is to engage with the apparatus to secure the apparatus relative to the wall.

A method is also described. The method includes forming a wall plate having a generally planar geometry. The method also includes defining a storage groove along a perimeter of the wall plate opening radially outward relative to a center of the wall plate. The method also includes coupling a retaining strap to the wall plate to receive a door knob in an engaged position and to seat into the storage groove in a storage position.

### BRIEF DESCRIPTION OF THE DRAWINGS

In order that the advantages of the subject matter may be more readily understood, a more particular description of the subject matter briefly described above will be rendered by reference to specific embodiments that are illustrated in the appended drawings. Understanding that these drawings depict only typical embodiments of the subject matter and are not therefore to be considered to be limiting of its scope, the subject matter will be described and explained with additional specificity and detail through the use of the drawings, in which:

FIG. 1 is a schematic diagram illustrating one embodiment of a system for maintaining the position of a door relative to a wall;

FIG. 2 is a perspective view diagram illustrating one embodiment of the system in accordance with embodiments of the present invention;

FIG. 3 is a perspective view diagram illustrating one embodiment of the wall engaging surface of the wall plate in accordance with embodiments of the invention;

FIG. 4 is a perspective view diagram illustrating one embodiment of the wall facing surface of the wall plate in accordance with embodiments of the invention;

FIG. 5 is a perspective view diagram illustrating one embodiment of the wall engaging surface of the wall plate in accordance with embodiments of the invention; and

FIG. 6 is a flowchart of a method in accordance with embodiments of the invention.

### DETAILED DESCRIPTION

The subject matter of the present application has been developed in response to the present state of the art, and in particular, in response to the problems and needs in the art that have not yet been fully solved by currently available fuel receivers. Accordingly, the subject matter of the present application has been developed to provide a fluid receiver that overcomes at least some shortcomings of the prior art.

Described herein are various embodiments of a wall protector and door catch. The majority of hinged doors have a door knob of some type or style. The door knob may be spherical, or formed with a handle. In either situation, the door knob protrudes from the planar surface of the door. For various reasons (e.g., wind, children, etc.), the door knob often impacts the wall when the door is opened and causes damage to the wall. If the reason is wind, the door may slam open and shut multiple times, causing further damage to the wall and a dangerous situation where fingers may be caught in the door jam. Beneficially, the system described herein provides a mechanism to both protect the wall and secure the door in an open position.

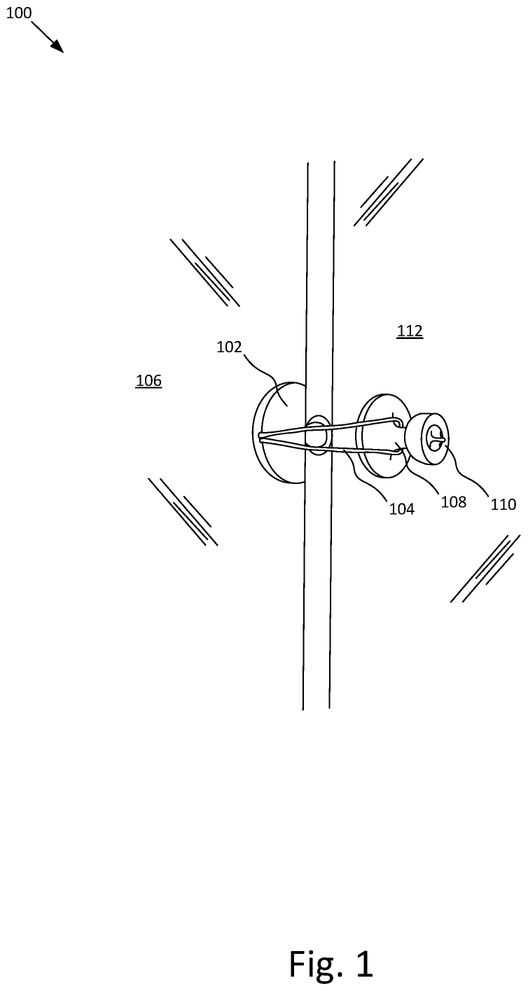

FIG. 1 is a schematic diagram illustrating one embodiment of a system 100 for maintaining the position of a door relative to a wall. The system 100 comprises a combination wall protector and door catch formed of a wall plate 102 and an integrated retaining strap 104. The wall plate 102 is attachable to a wall 106 and positionable to protect the wall 106 from a door knob. The wall plate 102 may be formed of a single impact resistant material designed to protect the wall 106 from impact damage from a door knob. Examples of impact resistant materials include, but are not limited to, wood, metal, and plastic. In further embodiments, the wall plate 102 is formed of multiple materials. For example, the wall plate 102 may be formed having a plastic base plate and a rubberized bumper protruding from the base plate.

The door 112, in one embodiment, is hinged and configured to transition from a closed position to an open position. As used herein, the phrase “closed position” refers to a position where the door blocks an opening. The “open position,” on the other hand, refers to a position where the door does not impede passage through the opening. The embodiment of FIG. 1 depicts a door in the open position. Stated differently, the door 112 is in a fully open position when the door 112 is adjacent to the wall 106 and the door knob is in contact with the wall plate 102. Although the description herein, with reference to FIGS. 1-5, refers primarily to a hinged door such as the door 112 of FIG. 1, the system 100 may be equally applied to other types of doors, including but not limited to, sliding doors, pocket doors, etc. In other words, any door with a protruding feature (e.g., a door knob or other protrusion) is capable of use with the system 100.

Attached with the wall plate 102 is the retaining strap 104. The retaining strap 104, in one embodiment, is a loop of material that originates and terminates at the wall plate 102. The retaining strap 104 is configured with a length sufficient to extend around the base of a door knob 110 in an “engaged position” of the retaining strap 104. In this manner, the retaining strap 104 secures the door 112 and prevents the door from closing. The retaining strap 104 may be a continuous loop, as will be described below, or alternatively, a length of material having first and second ends attached with the wall plate 102. The retaining strap 104 may be formed of a resilient elastic material such as a shock or bungee. The retaining strap 104, in one embodiment, is formed of one or more elastic strands and covered in a woven sheath. In other embodiments, the retaining strap 104 may be non-elastic and formed of nylon webbing. In a non-elastic configuration, the retaining strap 104 is detachable at one end from the wall plate 102 so that the retaining strap 104 may be wrapped around the door knob and reattached to the wall plate 102. Other materials that are capable of securing the door knob are contemplated.

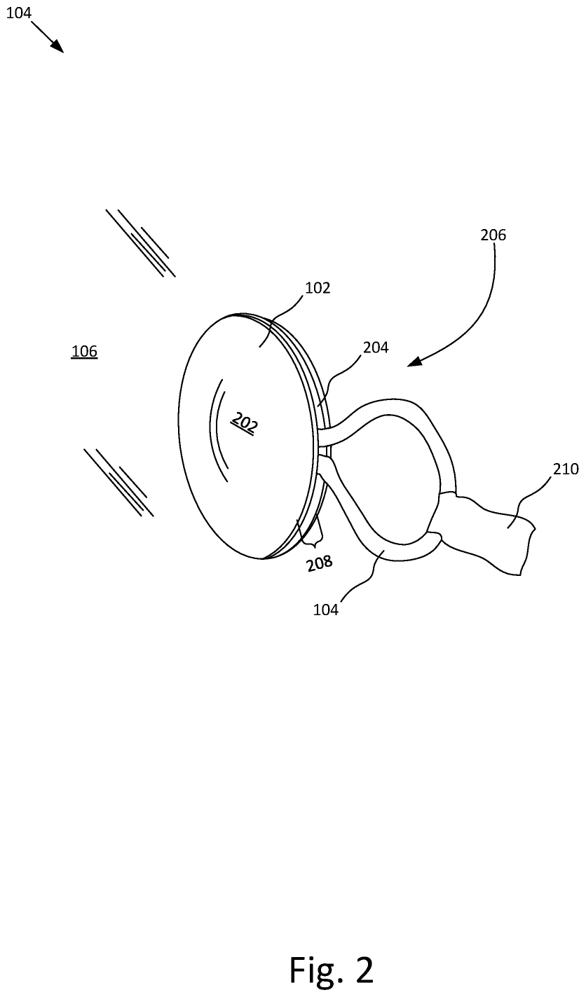

FIG. 2 is a perspective view diagram illustrating one embodiment of the system 100 in accordance with embodiments of the present invention. The system 100, as described above, includes the wall plate 102 and the retaining strap 104. The wall plate 102 may be substantially circular with a diameter selected to engage the door knob. Stated differently, the diameter of the wall plate 102, and subsequently the surface area, is at least larger than a contact surface of the door knob. In one embodiment, the diameter of the wall plate is in the range of between about 1 and 8 inches. In another embodiment, the wall plate 102 may have a square or rectangular shape. In other embodiments, the wall plate 102 may be formed having any desired geometric shape including, but not limited to, hexagonal, octagonal, etc.

The wall plate 102 may be formed of a plastic material, examples of which include but are not limited to, ABS plastic. Other rigid polymers may also be utilized. The door facing surface 202 of the wall plate 102 may be curved, as depicted. Alternatively, the door facing surface 202 of the wall plate 102 may be formed with a profile selected to engage a predetermined door knob. In other words, the profile of the door facing surface 202 may have an indentation configured to engage the door knob.

In another embodiment, the wall plate 102 may be formed of multiple materials, each material having a different shock absorbing capability. For example, the wall plate 102 may be formed of a rigid base coupled with a resilient rubber material for absorbing the impact of the door knob.

The retaining strap 104, as described above, is coupled with the wall plate 102 and configured to extend from the wall plate 102 and engage the door knob. The retaining strap 104 may be stretchable around the door knob, or alternatively, detachable from the wall plate 102 so that the retaining strap 104 wraps around the door knob to secure the door to the wall plate 102.

As will be described in greater detail below, the retaining strap 104 may be stored by stretching the retaining strap 104 around the perimeter of the wall plate 102 such that the retaining strap 104 is embedded in a storage groove 204. The storage groove 204, in one embodiment, is a channel that is disposed between the outer surface (i.e., the door facing surface 202) and an inner surface 206 (i.e., the wall engaging surface). In another embodiment, the storage groove 204 is formed by a radial ridge around the perimeter of the wall plate 102 and the wall. The storage groove 204 is configured with a width 208 selected to receive the retaining strap 104. In other words, the width 208 of the storage gap is determined according to the size of the retaining strap 104. For example, if the retaining strap 104 is a tubular bungee cord having a ⅜″ diameter, the width 208 of the storage gap 204 is at least ⅜″. The storage groove 204 may extend around an entire perimeter of the wall plate 102 or along only a portion of the perimeter of the wall plate 102.

In one embodiment, the system 100 also includes a pull tab 210. The pull tab 210, in one example, is a flexible length of material coupled with the retaining strap 104 to allow a person to easily extract the retaining strap 104 from the wall plate 102 and stretch the retaining strap 104 around a door knob. In one embodiment, the pull tab 210 is formed of nylon webbing attached to the retaining strap 104. In another embodiment, the pull tab 210 is any protrusion from the retaining strap 104 that allows a person to extract the retaining strap 104 from the storage groove 204. For example, the pull tab 210 may be a knot tied in the retaining strap 104 to prevent the entire retaining strap 104 from embedding in the storage groove 204. Other examples include, but are not limited to wire, fabric, etc.

In certain embodiments, the wall plate 102 is formed of a paintable surface. For example, the wall plate 102 may be formed of a plastic material that is capable of being painted. In this manner, the wall plate 102 may be painted to match the wall. In other embodiments, the wall plate 102 may be configured to receive an image. Stated differently, the wall plate 102 is capable of either receiving or being printed with a picture. Examples of pictures include, sports team's logos, scenic views, animals, people, etc.

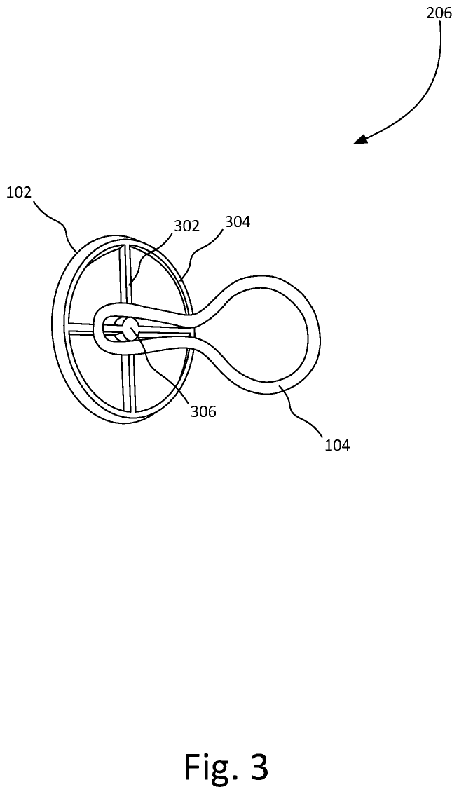

FIG. 3 is a perspective view diagram illustrating one embodiment of the wall engaging surface 206 of the wall plate 102 in accordance with embodiments of the invention. The wall plate 102, as discussed above, may be formed of a rigid polymeric material such as ABS. The wall plate 102 may be formed by injection molding, or other any other manufacturing process capable of forming the impact resistant wall plate 102. In the depicted embodiment, the wall plate 102 is formed with support ridges 302 that strengthen the wall plate 102 while reducing the need for an entirely solid wall plate 102.

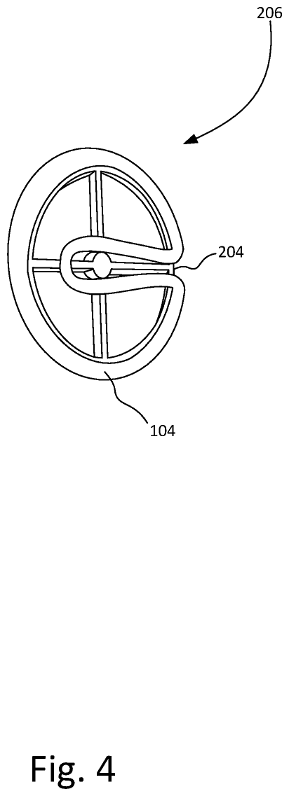

Cavities formed between the support ridges 302 and the perimeter 304 of the wall plate 102 allow for the coupling of the retaining strap 104, as shown. Channels formed in the support ridges 302 are sized to allow a friction fit of the retaining strap 104. In a further embodiment, the retaining strap 104 may be adhered or otherwise coupled to the wall plate 102. In the depicted embodiment, the retaining strap 104 is an endless loop that passes through channels in the support ridges 302 and the perimeter 304 of the wall plate 102. Alternatively, the retaining strap 104 may be of a finite length having first and second ends, each of which are coupled to the wall plate 102. As will be described in greater detail below with reference to FIG. 4, the retaining strap 104 may be stored by stretching the retaining strap 104 around the outer surface of the perimeter 304.

The wall plate 102 may be attachable to the wall via a fastener. In one embodiment, the fastener passes through the center 306 of the wall plate 102 and attaches to the wall. For example, the fastener may be a wood screw that couples to a stud in the wall. In an alternative embodiment, the fastener is an adhesive for securing the wall plate 102 to the wall. For instance, the adhesive may be a double-sided adhesive tape adhered to the support ridges 302 and the perimeter 304 such that when the wall plate 102 is positioned on the wall, and pressure is applied, the wall plate 102 adheres to the wall.

FIG. 4 is a perspective view diagram illustrating one embodiment of the wall facing surface 206 of the wall plate in accordance with embodiments of the invention. The depicted embodiment illustrates the retaining strap 104 positioned in the storage groove 204. As described previously, the retaining strap 104 may be stretched around the perimeter of the base plate and stored in the storage groove 204. The term “perimeter” as used herein, refers to the exterior lateral, or side, surface of the wall plate. The shape of the wall plate may be circular, elliptical, or any geometric shape with edges/corners (e.g., square, rectangle, pentagon, hexagon, etc.).

The retaining strap 104 is configured with a length selected to stretch or wrap around the perimeter of the wall plate. In other words, if the retaining strap is elastic, then the length of the retaining strap is sufficient enough to stretch around the wall plate. If the retaining strap is non-elastic, the length of the retaining strap 104 is sufficient to wrap around the perimeter of the wall plate.

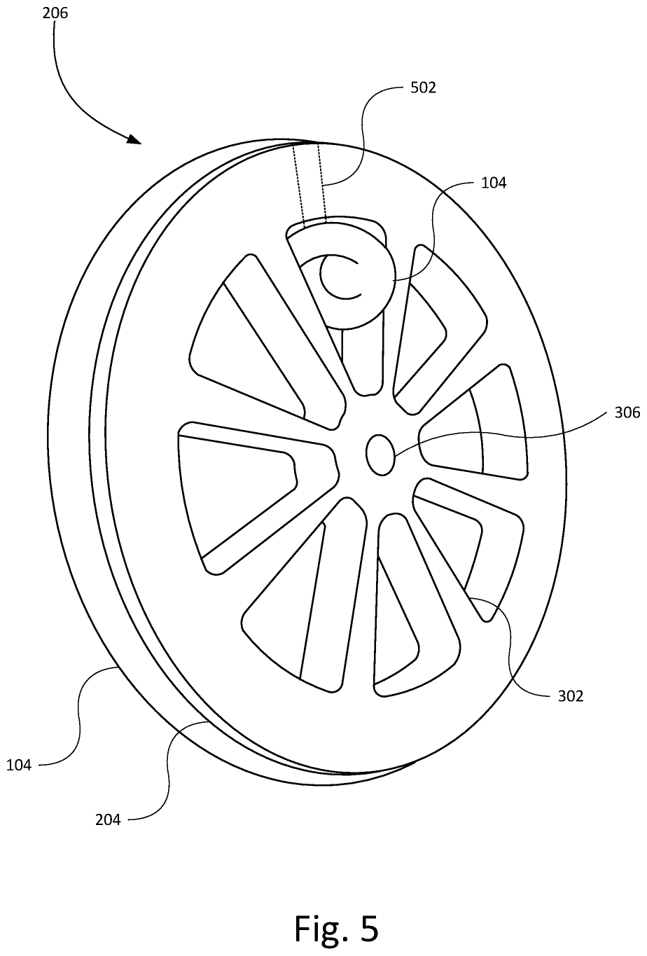

FIG. 5 is a perspective view diagram illustrating one embodiment of the wall facing surface 206 of the wall plate 102 in accordance with embodiments of the invention. In the illustrated embodiment, the wall plate 102 includes multiple support ridges 302 radiating outward from a center 306 of the wall plate 102. In some embodiments, the center 306 of the wall plate 102 includes at least part of a mounting location to facilitate engagement of a fastener to secure the wall plate 102 relative to a wall 106. In some embodiments, the fastener may be a screw, nail, adhesive, hook, drywall anchor, suction cup, magnet, or the like.

In some embodiments, the fastener may correspond to a recessed portion at mounting location at the center 306 of the wall plate 102. While a single mounting location at the center 306 of the wall plate 102 is shown, other embodiments include a mounting location at a location away from the center 306 of the wall plate or may include more than one mounting location. In some embodiments, the mounting location is a through-hole and may include a recess in the door facing surface 202 to reduce impact on the screw by the door knob 110. In other embodiments, the mounting location may include a key slot, a hook, a magnet, or the like.

In the illustrated embodiment, the retaining strap 104 is seated into the storage groove 204 in a “storage position” of the retaining strap 104. Additionally, as shown in the illustrated embodiment, the retaining strap 104 is secured relative to the wall plate 102 by passing the retaining strap 104 through a channel 502 of the wall plate 102. In some embodiments, the channel 502 is formed in the storage groove 204 and the retaining strap 104 is passed through the channel 502 and a knot or other geometry that is larger than the channel 502 is formed to maintain a portion of the retaining strap 104 within the wall plate 102.

In some embodiments, the retaining strap 104 may be knotted or otherwise joined or the retaining strap 104 may be a continuous loop. In some embodiments, the retaining strap 104 is detachable to open and close a loop of the retaining strap 104. In other embodiments, the retaining strap 104 is a continuous loop with no break or disconnect features.

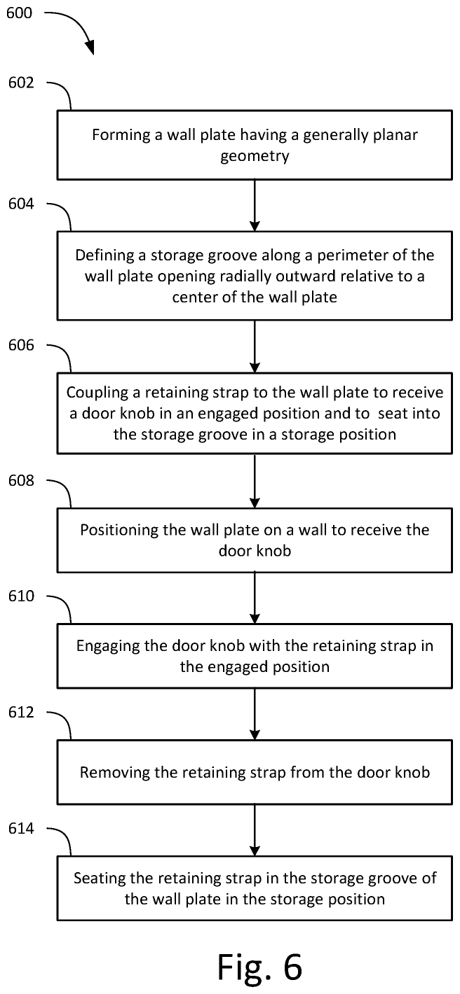

FIG. 6 is a flowchart of a method 600 in accordance with embodiments of the invention. The method 600 includes, at block 602, forming a wall plate 102 having a generally planar geometry. In some embodiments, the geometry of the wall plate 102 is round and generally planar on both a door facing side 202 and a wall facing surface 206. Other shapes and geometries may be incorporated.

At block 604, the method 600 includes defining a storage groove 104 along a perimeter of the wall plate 102 opening radially outward relative to a center 306 of the wall plate 102. In some embodiments, the storage groove 204 extends around an entire perimeter of the wall plate 102. In other embodiments, the storage groove 204 extends around a portion of the perimeter of the wall plate 102.

At block 606, the method 600 includes coupling a retaining strap 104 to the wall plate 102 to receive a door knob 110 in an engaged position and to seat into the storage groove 204 in a storage position. In some embodiments, the retaining strap 104 is detachable to receive the door knob 110. In other embodiments, the retaining strap 104 forms a complete loop.

At block 608, the method 600 includes positioning the wall plate 102 on a wall to receive the door knob 110. Positioning the wall plate 102 on the wall may include the use of fasteners, adhesives, bonding elements, and the like.

At block 610, the method 600 includes engaging the door knob 110 with the retaining strap 104. At block 612, the method 600 includes removing the retaining strap 104 from the door knob 110. In some embodiments, the retaining strap 104 is engaged and disengaged from the door knob 110 by looping the retaining strap 104 over the door knob 110. In other embodiments, the retaining strap 104 is engaged and disengaged from the door knob 110 by opening or uncoupling the retaining strap 104 and reconnecting or closing the retaining strap 104.

At block 614, the method 600 includes seating the retaining strap 104 in the storage groove 204 of the wall plate 102 in the storage position. In some embodiments, the storage groove 204 includes other structures or features. For example, the storage groove 204 may include a hook, ridge, clip, or the like to retain the retaining strap 104 in the storage groove 204.

Reference throughout this specification to features, advantages, or similar language does not imply that all of the features and advantages that may be realized with the subject matter of the present disclosure should be or are in any single embodiment. Rather, language referring to the features and advantages is understood to mean that a specific feature, advantage, or characteristic described in connection with an embodiment is included in at least one embodiment of the present disclosure. Thus, discussion of the features and advantages, and similar language, throughout this specification may, but do not necessarily, refer to the same embodiment.

Furthermore, the described features, advantages, and characteristics of the subject matter of the present disclosure may be combined in any suitable manner in one or more embodiments. One skilled in the relevant art will recognize that the subject matter may be practiced without one or more of the specific features or advantages of a particular embodiment. In other instances, additional features and advantages may be recognized in certain embodiments that may not be present in all embodiments. These features and advantages will become more fully apparent from the following description and appended claims or may be learned by the practice of the subject matter as set forth hereinafter.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

Furthermore, the details, including the features, structures, or characteristics, of the subject matter described herein may be combined in any suitable manner in one or more embodiments. One skilled in the relevant art will recognize, however, that the subject matter may be practiced without one or more of the specific details, or with other methods, components, materials, and so forth. In other instances, well-known structures, materials, or operations are not shown or described in detail to avoid obscuring aspects of the disclosed subject matter.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a wall plate attachable to a wall and comprising a door facing surface, the door facing surface configured to stop a door knob extending from a door;
a retaining strap coupled with the wall plate and forming a loop, wherein the loop extends from the wall plate and engages the door knob; and
a storage groove disposed between a perimeter of the wall plate and the wall, the storage groove configured to receive the retaining strap.

2. The apparatus of claim 1, wherein the retaining strap is at least partially elastic.

3. The apparatus of claim 1, wherein the retaining strap is coupled to the wall plate at the storage groove.

4. The apparatus of claim 1, wherein wall plate comprises a mounting location to facilitate engagement of a fastener.

5. The apparatus of claim 4, wherein the fastener is an adhesive element.

6. The apparatus of claim 4, wherein the fastener is a screw and the wall plate includes a screw location.

7. The apparatus of claim 6, wherein the screw location is centrally located in the wall plate.

8. The apparatus of claim 1, wherein the door facing surface includes an impact resistant surface.

9. The apparatus of claim 1, wherein the retaining strap forms a complete loop.

10. The apparatus of claim 1, wherein the retaining strap is detachable to open and close the loop.

11. The apparatus of claim 1, wherein the retaining strap is coupled to the wall plate within the wall plate.

12. The apparatus of claim 11, wherein the retaining strap is coupled to the wall plate by a knot joining two ends of the retaining strap together within the wall plate.

13. The apparatus of claim 1, wherein the wall plate further includes support ridges extending radially outward from a center of the wall plate.

14. A system comprising:
an apparatus to mount to a wall to protect the wall from impact by a door knob, the apparatus comprising:
a wall plate attachable to the wall and comprising a door facing surface, the door facing surface configured to stop the door knob extending from a door;
a retaining strap coupled with the wall plate and forming a loop, wherein the loop extends from the wall plate and engages the door knob to retain the door knob proximal the apparatus; and
a storage groove disposed in a radial edge of the wall plate, the storage groove configured to receive and store the retaining strap; and
a fastener to engage with the apparatus to secure the apparatus relative to the wall.

15. The system of claim 14, wherein the wall plate further includes a mounting location to receive the fastener.

16. The system of claim 15, wherein the mounting location is configured to receive a screw.

17. The system of claim 16, further comprising a supplemental attachment to facilitate an interface between the screw and the wall.

18. The system of claim 16, wherein the mounting location comprises a recess to reduce impact on the screw by the door knob.

19. The system of claim 15, wherein the fastener is an adhesive element.

20. A method comprising:
forming a wall plate having a generally planar geometry;
defining a storage groove along a perimeter of the wall plate opening radially outward relative to a center of the wall plate;
coupling a retaining strap to the wall plate to receive a door knob in an engaged position and to seat into the storage groove in a storage position.
